(19) United States
(12) Patent Application Publication
(10) Pub. No.: US 2001/0047844 A1
(43) Pub. Date: Dec. 6, 2001

(54) Composites of reinforcing fibers and thermoplastic resins as external structural supports

(76) Inventors: Christopher M. Edwards, Midland, MI (US); Edward L. D'Hooghe, Hulst (NL)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/756,448

(22) Filed: Jan. 8, 2001

Related U.S. Application Data
(60) Provisional application No. 60/175,934, filed on Jan. 13, 2000.

(51) Int. Cl. B32B 7/04

(52) U.S. Cl. 156/91

(57) ABSTRACT

An external reinforcement for structures includes a composite of longitudinally oriented reinforcing fibers in a thermoplastic matrix. The reinforcement is useful to shore up damaged structures or to provide, for example, additional protection against natural phenomena such as earthquakes or storms.

### CROSS-REFERENCE STATEMENT

This application claims the benefit of U.S. Provisional application No. 60/175,934, filed Jan. 13, 2000.

### BACKGROUND OF THE INVENTION

This invention relates to external reinforcements for building structures.

It is often necessary to reinforce a building structure. Damage, weathering or aging can weaken a structure, requiring some reinforcement to be applied to prevent collapse or further damage. In some areas, reinforcement is necessary to strengthen the structure enough to withstand anticipated conditions such as an earthquake or high winds.

One way this reinforcement is provided is by applying a thermoset composite to the surface of the structure. For example, road and bridge supports in earthquake-prone areas have been overwrapped with a sheet-like composite of a thermoset resin and a reinforcing fiber, usually glass and especially carbon. Buildings have been reinforced in a similar way. Moreover, thermoset composites have been applied as a sort of patch over cracks in buildings and other structures.

Unfortunately, these thermoset composites are difficult to use, and must be applied in one of two ways. Either the composite is applied to the structure while the matrix polymer is in an uncured or semi-cured state, followed by curing, or else some separate adhesive must be applied. In either case, the installation of thermoset composite reinforcements is slow, difficult and messy. In addition, the thermoset composites cannot be thermoformed once the polymer has cured. This effectively prevents thermoset composites from being shaped on-site to meet specific needs.

Thus, thermoset composites have distinct disadvantages that limit their use as external reinforcements for building structures. It would be desirable to provide an improved method by which an external reinforcement can be provided.

### SUMMARY OF THE INVENTION

In one aspect, this invention is a method for providing external reinforcement to a structure, comprising applying to a surface of said structure a reinforcing tape or rod comprising a composite of a plurality of longitudinally oriented reinforcing fibers in a matrix of a thermoplastic resin.

This method provides several benefits. First, the reinforcing tape can be applied in a simplified manner by heating the tape sufficiently to soften the thermoplastic resin. The heated tape can then be applied to the surface of the structure, and often can be adhered to the surface of the underlying structure without the need for additional glues or adhesives. The reinforcing tape is also adaptable for use with a wide variety of mechanical attachment devices. Furthermore, the reinforcing tape is thermoformable, so that it can be easily wrapped tightly over and around complex shapes. Because it is thermoformable, the reinforcing tape can also be shaped to key into the structure, thereby forming mechanical bonds to the structure that supplement the adhesion of the tape.

In a second aspect, this invention is a structure that is reinforced on at least one external surface with a reinforcing tape or rod comprising a composite of a plurality of longitudinally oriented reinforcing fibers in a matrix of a thermoplastic resin.

In a third aspect, this invention is a reinforcing tape comprising a composite of a plurality of longitudinally oriented reinforcing fibers in a matrix of a thermoplastic resin.

### BRIEF DESCRIPTION OF THE DRAWING

The Figure is an isometric view of a structure reinforced with a reinforcing tape according to the invention.

### DESCRIPTION OF THE INVENTION

The reinforcing tape used in this invention comprises a composite of longitudinally oriented reinforcing fibers embedded in a matrix of a thermoplastic resin. It is conveniently made in a pultrusion process as described in U.S. Pat. No. 5,891,560 to Edwards et al.

The reinforcing fiber can be any strong, stiff fiber that is capable of being processed into a composite through a pultrusion process. Glass, other ceramics, carbon, metal or high melting polymeric (such as aramid) fibers are suitable. Mixtures of different types of fibers can be used. Moreover, fibers of different types can be layered or interwoven within the composite in order to optimize certain desired properties. For example, glass fibers can be used in the interior regions of the composite and more expensive fibers such as carbon fibers used in the exterior regions. This permits one to obtain the benefits of the high stiffness of the carbon fibers while reducing the overall fiber cost.

Glass is a preferred fiber due to its low cost, high strength and good stiffness. Carbon fibers are especially preferred because of their excellent strength and stiffness.

Suitable fibers are well known and commercially available. Fibers having diameters in the range of about 10 to 50 microns, preferably about 15-25 microns, are particularly suitable.

The reinforcing fibers are longitudinally oriented within the composite. By “longitudinally oriented”, it is meant that the reinforcing fibers extend essentially continuously throughout the entire length of the composite and are aligned in the direction of pultrusion.

As it is the fibers that mainly provide the desired reinforcing properties, the fiber content of the composite is preferably as high as can conveniently be made. The upper limit on fiber content is limited only by the ability of the thermoplastic resin to wet out the fibers and adhere them together to form an integral composite without significant void spaces. The fibers advantageously constitute at least 30 volume percent of the composite, preferably at least 50 volume percent and more preferably at least 65 volume percent.

The thermoplastic resin can be any that can be adapted for use in a pultrusion process to form the composite and which does not undesirably react with the reinforcing fibers. However, the thermoplastic resin preferably has additional characteristics. The thermoplastic resin preferably is a rigid polymer, having a glass transition temperature (T_{g}) of not less than 50° C. In addition, the thermoplastic resin preferably forms a low viscosity melt during the pultrusion process, to facilitate wetting out the reinforcing fibers. The thermoplastic resin preferably does not react with concrete in an undesirable way and is substantially inert to (i.e., does not react with, absorb, dissolve or significantly swell when exposed to) water and common salts. Among the useful thermoplastics are the so-called “engineering thermoplastics”, including polystyrene, polyvinyl chloride, ethylene vinyl acetate, ethylene vinyl alcohol, polybutylene terephthalate, polyethylene terephthalate, acrylonitrile-styrene-acrylic, ABS (acrylonitrile-butadiene-styrene), polycarbonate, aramid and polypropylene resins, and blends thereof

A particularly suitable thermoplastic resin is a depolymerizable and repolymerizable thermoplastic (DRTP). Examples of these are rigid thermoplastic polyurethanes or polyureas (both referred to herein as “TPUs”). TPUs have the property of partially depolymerizing when heated due in part to the presence of residual polymerization catalyst. The catalyst is typically hydrolytically- and thermally-stable and is “live” in the sense that it is not inactivated once the TPU has been polymerized. This depolymerization allows the TPU to exhibit a particularly low melt viscosity, which enhances wet-out of the fibers. Upon cooling, the polyurethane repolymerizes to again form a high molecular weight polymer.

In addition, TPUs tend to form particularly strong adhesive bonds to concrete.

Suitable thermoplastic polyurethanes are described, for example, in U.S. Pat. No. 4,376,834 to Goldwasser et al. Fiber-reinforced thermoplastic composites suitable for use in the invention and which are made using such rigid TPUs are described in U.S. Pat. No. 5,891,560 to Edwards et al.

The composites described in U.S. Pat. No. 5,891,560 include a continuous phase of which is advantageously a polyurethane or polyurea (or corresponding thiourethane or thiourea) impregnated with at least 30 percent by volume of reinforcing fibers that extend through the length of the composite. The general pultrusion process described in U.S. Pat. No. 5,891,560 includes the steps of pulling a fiber bundle through a preheat station a fiber pretension unit, an impregnation unit, a consolidation unit that includes a die which shapes the composite to its finished shape, and a cooling die. The pulling is advantageously accomplished using a haul off apparatus, such as a caterpillar-type haul off machine. Additional shaping or post-forming processes can be added as needed.

As described in U.S. Pat. No. 5,891,560, the preferred continuous phase polymer is a thermoplastic polyurethane or polyurea made by reacting approximately stoichiometric amounts of (a) a polyisocyanate that preferably has two isocyanate groups per molecule, (b) a chain extender, and optionally (c) a high equivalent weight (i.e., above 250 to about 4000 eq. wt.) material containing two or more isocyanate-reactive groups. By “chain extender”, it is meant a compound having two isocyanate-reactive groups per molecule and a molecular weight of up to about 500, preferably up to about 200. Suitable isocyanate-reactive groups include hydroxyl, thiol, primary amine and secondary amine groups, with hydroxyl, primary and secondary amine groups being preferred and hydroxyl groups being particularly preferred.

Preferred TPUs are rigid, having a T_{g} of at least 50° C. and a hard segment content (defined as the proportion of the weight of the TPU that is made up of chain extender and polyisocyanate residues) of at least 75%. Rigid thermoplastic polyurethanes are commercially available under the trade name ISOPLAST® engineering thermoplastic polyurethanes. ISOPLAST is a registered trademark of The Dow Chemical Company.

“Soft” polyurethanes having a T_{g} of 25° C. or less can be used, but tend to form a more flexible composite. Thus, “soft” polyurethanes are preferably used as a blend with a rigid thermoplastic polyurethane. The “soft” polyurethane is generally used in a proportion sufficient to increase the elongation of the composite (in the direction of the orientation of the fibers). This purpose is generally achieved when the “soft” polyurethane constitutes 50% or less by weight of the blend, preferably 25% or less.

The preferred DRTP can be blended with minor amounts (i.e., 50% by weight or less) of other thermoplastics, such as polystyrene, polyvinyl chloride, ethylene vinyl acetate, ethylene vinyl alcohol, polybutylene terephthalate, polyethylene terephthalate, acrylonitrile-styrene-acrylic, ABS (acrylonitrile-butadiene-styrene), polycarbonate, polypropylene and aramid resins. If necessary, compatibilizers can be included in the blend to prevent the polymers from phase separating.

The reinforcing tape is conveniently prepared by simply pultruding a sheet of fiber reinforced composite, advantageously using the general method described in U.S. Pat. No. 5,891,560, in the desired thickness.

The thickness of the tape will depend on factors such as the required strength of the reinforcement and the need for the tape to be sufficiently flexible that it can be formed into rolls for transportation. A suitable thickness is from about 0.005 to about 0.1 inch, preferably from about 0.01 to about 0.05 inch, more preferably from about 0.02 to about 0.04 inch. The reinforcing tape can be formed in any convenient length and width. A suitable width is from about 1 inch, preferably from about 3 inches, more preferably from about 6 inches, to about 80 inches or more, preferably to about 40 inches.

The reinforcing tape can be applied to a structure in a variety of ways. For wrapping structures like pillars, a convenient way of applying the reinforcing tape is to wrap the tape around the pillar, tension the tape and heat the tape to soften the thermoplastic matrix. An infrared heater, microwave heater or magnetic heater is suitable for this purpose. The thus-heated tape can then be rolled or otherwise pressed against the underlying pillar (while maintaining tension) in order to obtain good contact between the softened thermoplastic matrix and the surface of the underlying pillar. Upon cooling, the thermoplastic matrix provides the bond between the tape and the underlying pillar. If desired, additional adhesives such as thermoset or hot melt adhesives can be used to improve the bond to the underlying surface.

In a variation of the foregoing technique, dry tape is wrapped around the pillar, with some overlap of the tape with itself. The tape is pretensioned and the overlapping portions of the tape are then heated as before, to cause the overlapping portions of the tape to adhere to each other. Alternatively, a separate adhesive, such as a thermoset adhesive or hot melt adhesive, can be used to secure the ends of the tape together. Also, any mechanical means can be used to secure the ends of the tape together. Combinations of these methods of securing the ends of the tape together can be used.

Similar methods can be used to apply the reinforcing tape other structures, such as walls or entire buildings.

Note that this reinforcing tape is useful with a wide variety of structures and materials of construction. Thus, the structure that is reinforced according to the invention can be a wall, a building support, a highway or bridge pillar or support, an office, home or other building, a roadway, a tunnel, a runway, or many other types of structures. The structure can be masonry, such as brick, stone or the like, or can be of concrete, frame or any other type of construction. Structures of particular interest are masonry and concrete structures, as they are sometimes prone to cracking.

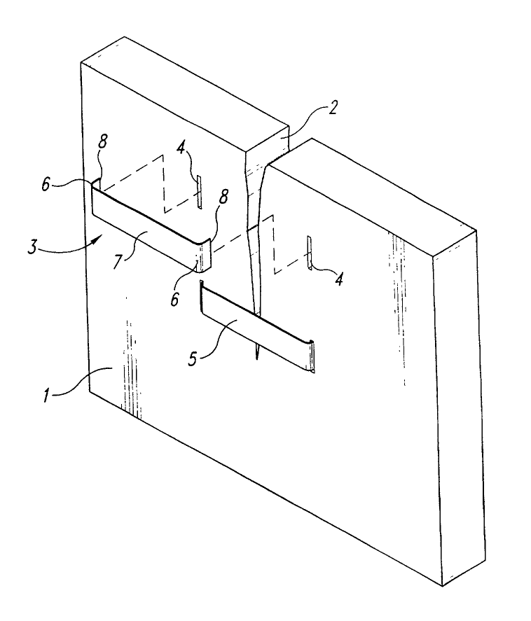

FIG. 1 illustrates another method for applying the reinforcing tape, which takes advantage of a desirable feature of the invention. In FIG. 1, structure 1 has vertical crack 2. Reinforcing tape (or rod) 3 is shown poised for positioning across crack 2. Reinforcing tape 3 has thermoformed bends 6, forming end sections 8 that, as shown, are roughly perpendicular to the main body 7 of reinforcing tape 3. To apply reinforcing tape 3, holes 4 are made in structure 1. Holes 4 are shaped and located relative to each other so that they receive end sections 8 of reinforcing tape 3. When reinforcing tape 3 is applied, end sections 8 are inserted into holes 4. Reinforcing tape 3 may be adhered to structure 1 as well, such as through the use of a separate adhesive or by heating reinforcing tape 3 and applying pressure to ensure good contact between the surface of structure 1 with the thermoplastic resin matrix as described above. Thus, the adhesive bond is supplemented by a mechanical interlocking into structure 1.

As shown in FIG. 1, another reinforcing tape 5 of the invention has previously been applied in like manner, and is similarly keyed into structure 1. The reinforcing tape 3 and 5 may or may not be pretensioned when applied. Even if not pretensioned, the reinforcing tape will help to prevent the propagation of crack 2.

Bends of the sort illustrated in FIG. 1 are conveniently made on-line as part of the process of forming the composite, or can be made in some subsequent operation, including an on-site operation. Because the composite is readily formable, the reinforcing tape is easily adapted in the field to a wide variety of desired configurations.

In addition, various mechanical means for applying the reinforcing tape can be used. These include a wide variety of nails, screws, clips, holders, ties, overlayments, and the like.

What is claimed is:

1. A method for providing external reinforcement to a structure, comprising applying to a surface of said structure a reinforcing tape or rod comprising a composite of a plurality of longitudinally oriented reinforcing fibers in a matrix of a thermoplastic resin.

2. The method of claim 1, wherein said thermoplastic resin includes a depolymerizable and repolymerizable thermoplastic.

3. The method of claim 2, wherein said depolymerizable and repolymerizable thermoplastic is a thermoplastic polyurethane or polyurea having a T_{g} of not less than 50° C.

4. The method of claim 3, wherein said reinforcing fibers are glass, other ceramic, carbon, metal or polymeric fibers.

5. The method of claim 1, wherein said reinforcing tape is applied by heating said tape until the thermoplastic resin matrix is softened, applying pressure to said reinforcing tape so that said softened thermoplastic matrix contacts the surface of the structure and forms an adhesive bond thereto, and cooling said tape to reharden said thermoplastic matrix.

6. The method of claim 1, wherein said reinforcing tape is mechanically interlocked with said structure.

7. The method of claim 5, wherein said reinforcing tape is further applied to said structure through a mechanical means.

8. The method of claim 2, wherein the ends of said reinforcing tape are embedded in said structure.

9. The method of claim 2, wherein said thermoplastic resin is a blend of a depolymerizable and repolymerizable polyurethane or polyurea and a polystyrene, polyvinyl chloride, ethylene vinyl acetate, ethylene vinyl alcohol, polybutylene terephthalate, polyethylene terephthalate, acrylonitrile-styrene-acrylic, ABS (acrylonitrile-butadiene-styrene), polycarbonate, aramid or polypropylene resin.

10. A structure that is reinforced on at least one external surface with a reinforcing tape comprising a composite of a plurality of longitudinally oriented reinforcing fibers in a matrix of a thermoplastic resin.

11. The structure of claim 10, wherein said thermoplastic resin includes a depolymerizable and repolymerizable thermoplastic.

12. The structure of claim 11, wherein said depolymerizable and repolymerizable thermoplastic is a thermoplastic polyurethane or polyurea having a T_{g} of not less than 50° C.

13. The structure of claim 12, wherein said reinforcing fibers are glass, other ceramic, carbon, metal or polymeric fibers.

14. The structure of claim 10, wherein said reinforcing tape is applied by heating said tape until the thermoplastic resin matrix is softened, applying pressure to said reinforcing tape so that said softened thermoplastic matrix contacts the surface of the structure and form-s an adhesive bond thereto, and cooling said tape to reharden said thermoplastic matrix.

15. The structure of claim 13, wherein said thermoplastic resin is a blend of a depolymerizable and repolymerizable polyurethane or polyurea and a polystyrene, polyvinyl chloride, ethylene vinyl acetate, ethylene vinyl alcohol, polybutylene terephthalate, polyethylene terephthalate, acrylonitrile-styrene-acrylic, ABS (acrylonitrile-butadiene-styrene), polycarbonate, aramid or polypropylene resin.
